(19) United States
(12) Patent Application Publication
(10) Pub. No.: US 2026/0241399 A1
(43) Pub. Date: Aug. 20, 2026

(54) PUMP TOP FOR LIQUID DISPENSERS

(71) Applicant: World Club Supply Corp., Orange, CA (US)

(72) Inventors: Philip D. Lowance, Dana Point, CA (US); James Z. Monninger, Melbourne, FL (US)

(73) Assignee: World Club Supply Corp., Orange, CA (US)

(21) Appl. No.: 19/538,391

(22) Filed: Feb. 12, 2026

Related U.S. Application Data
(60) Provisional application No. 63/758,546, filed on Feb. 14, 2025.

(51) Int. Cl. B05B 11/10; B05B 11/02; F04B 43/12

(52) U.S. Cl. CPC B05B 11/1018; B05B 11/028; B05B 11/1001; B05B 11/1032; B05B 11/1047; B05B 11/1074; F04B 43/1253

(57) ABSTRACT

A pump top for a liquid dispenser comprises a flexible insert comprising a liquid guide providing a liquid flow path and a receptacle shaped to receive a spacer plug. The space plug has an inlet port configured to receive liquid dispensed from a pump stem and at least one outlet port configured to transfer liquid dispensed from the pump stem into the liquid flow path. The spacer plug is further configured to transfer force from the pump stem to an undersurface of a top half of the pump top while enabling liquid to flow from the pump stem into the liquid guide.

### REFERENCE TO RELATED APPLICATION

This application claims priority to and the benefit of U.S. Provisional Patent Application Ser. No. 63/758,546 filed Feb. 14, 2025, the contents of which is incorporated by this reference in its entirety herein.

### FIELD OF THE DISCLOSURE

The subject disclosure relates to apparatus for dispensing liquids, such as, for example and without limitation, lotions, hair products, skin products, massage products, hygienic products, dental products, sun care products, inhalant, food products, and more specifically and without limitation: hair shampoo, hair conditioner, hair gel, skin moisturizer, body fragrance, body wash, hand soap, shave crème, massage lotion, massage crème, massage oil, hand sanitizer gel, antibacterial skin soap, tooth paste, mouthwash, sun block, tanning oil, after sun crème, eucalyptus oil, coffee creams, coffee flavors, coffee sweeteners, mustard, ketchup, and mayonnaise.

More particularly, the disclosure pertains to a pump top for such apparatus.

### DESCRIPTION OF RELATED ART

Various devices for dispensing various liquids employing pump tops have been developed, for example, such as the liquid dispenser apparatus disclosed in U.S. Pat. No. 11,332,279, entitled “Liquid Dispenser Apparatus,” the contents of which is incorporated by reference herein in its entirety.

### SUMMARY

According to an illustrative embodiment, a pump top for a liquid dispenser comprises a flexible insert comprising a liquid guide, the liquid guide comprising a liquid flow path configured to conduct liquid to be dispensed, the flexible insert further comprising a receptacle formed therein and shaped to receive a spacer plug. A spacer plug is positioned in the receptacle and comprises an inlet port configured to receive liquid dispensed from a pump stem and at least one outlet port configured to transfer liquid dispensed from the pump stem into the liquid flow path.

In an illustrative embodiment, the spacer plug is configured to transfer force from the pump stem to an undersurface of the top half of the pump top while enabling liquid to flow from the pump stem into the liquid guide.

In one embodiment, the pump top may further comprise a top half and a bottom half with the flexible insert positioned between them and below the top half.

In some embodiments, the flexible insert may further comprise a flexible channel extending below the inlet port of the spacer plug for receiving the pump stem and guiding it to the spacer plug. In various embodiments, the flexible channel may form into a right-angle edge configured to provide a cushion against force applied by an adjacent surface of the pump as a head of the pump reaches a maximum compression position on a downstroke.

In one embodiment, the spacer plug may comprise a plurality of tabs extending from a top surface thereof and configured to mate with respective openings in the flexible insert to radially align the spacer plug and hold it in position. In one embodiment, the plurality of tabs comprise three tabs spaced apart 120 degrees from one another but may be differently configured in other embodiments.

In one embodiment, the liquid flow path may comprise first and second channels and the spacer plug may comprise first and second outlet ports for transferring liquid into a respective one of the first and second channels.

### DESCRIPTION OF THE DRAWINGS

FIG. 1 is side perspective view of a pump top for a liquid dispenser apparatus according to an illustrative embodiment;

FIG. 2 is a bottom perspective view of the pump top of FIG. 1 ;.

FIG. 3 is a side sectional view of the pump top of FIG. 1;

FIG. 4 is an exploded perspective view of the pump top of FIG. 1;

FIG. 5 is a second exploded perspective view of the pump top of FIG. 1;

FIG. 6 is a top view of a flexible insert component according to an illustrative embodiment;

FIG. 7 is a side sectional view illustrating an interface between a pump stem and a pump top according to an illustrative embodiment;

FIG. 8 is a partial side sectional view illustrating a pump stem and a portion of the pump top configured to receive it according to an illustrative embodiment;

FIG. 9 illustrates upper and lower closure components according to an illustrative embodiment;

FIG. 10 illustrates the pump top of the illustrative embodiment installed for up down actuation of a pump at a position prior to depression of the pump top; and

FIG. 11 illustrates the pump top of the illustrative embodiment installed for up down actuation of a pump at a position after full depression of the pump top.

### DETAILED DESCRIPTION OF ILLUSTRATIVE EMBODIMENTS

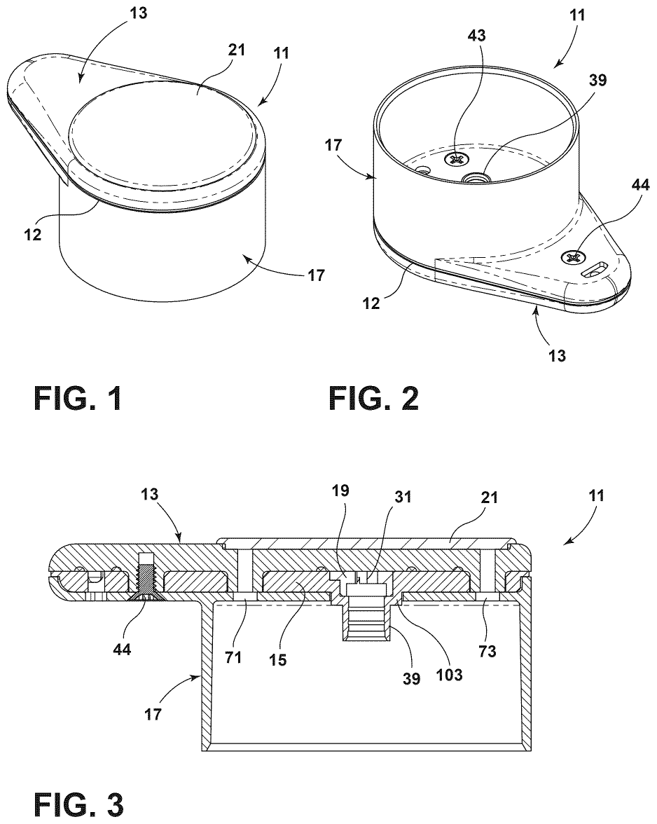

FIGS. 1-5 illustrate a pump top 11 according to an illustrative embodiment. The pump top 11 includes a top half 13, a bottom half 17, and a flexible silicone rubber or flexible plastic insert 15 positioned between the top and bottom halves 15, 17 to provide a liquid flow path within the pump top 11. The top half 13 forms a lid which encloses the top of the liquid flow path.

The pump top 11 further includes a rigid plastic spacer plug 19 and a circular medallion 21. In the illustrative embodiment, the rear perimeter of each of the top and bottom halves 13, 17 and the rear perimeter of the silicon rubber or flexible plastic insert 15 each follow the same semicircular contour.

In an illustrative embodiment, the top half 13 and bottom half 17 may be formed of a suitable metal, for example, stainless steel, and in one embodiment may each be a solid cast metal part. In one embodiment, the circular medallion 21 is a solid disc, again formed of a suitable metal or plastic, for example, stainless steel. The top half 13, bottom half 17, spacer 19 and medallion 21 may of course be formed of different materials and by various different fabrication methods in various other embodiments.

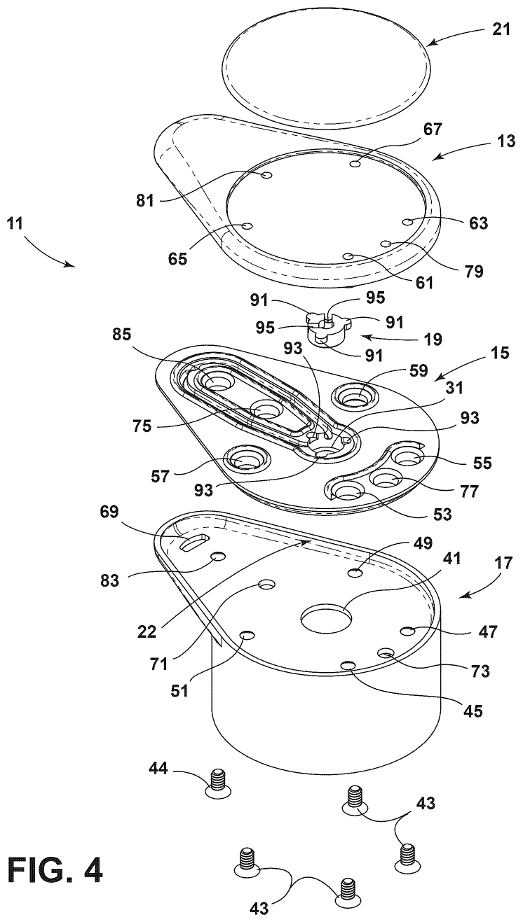

In one illustrative embodiment, the silicone rubber insert 15 is seated within an inner rim 22 (FIG. 4) of the lower pump top half 17. The insert 15 is sandwiched between the top half 13 and bottom half 17 and concealed from view by those components 13, 17, except for a thin exposed band 12 seen between the compressed top half 13 and bottom half 17.

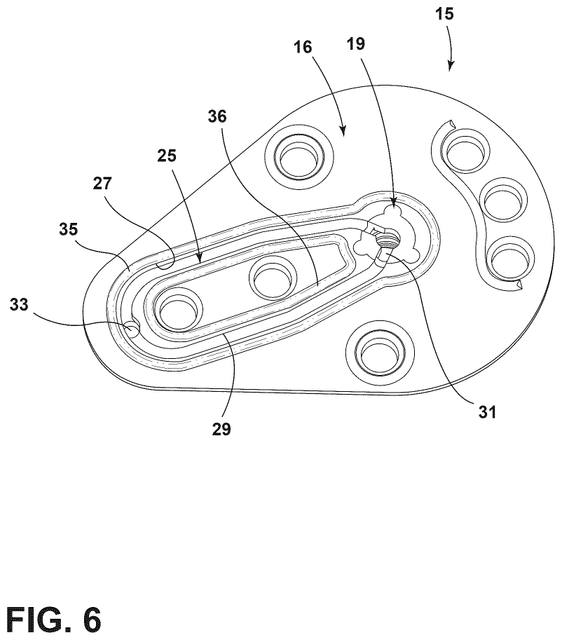

As seen in FIG. 6, the insert 15 provides a liquid guide comprising two channels formed by an outer vertical side surface 27 and an inner vertical side surface 29 on either side of a channel floor 25. In the illustrative embodiment, liquid to be dispensed flows from respective outlets of the spacer plug 19 through the two channels as discussed further below. The liquid guide guides liquid to be dispensed from a liquid inlet port 31 of the spacer plug 19 to a liquid outlet port 33.

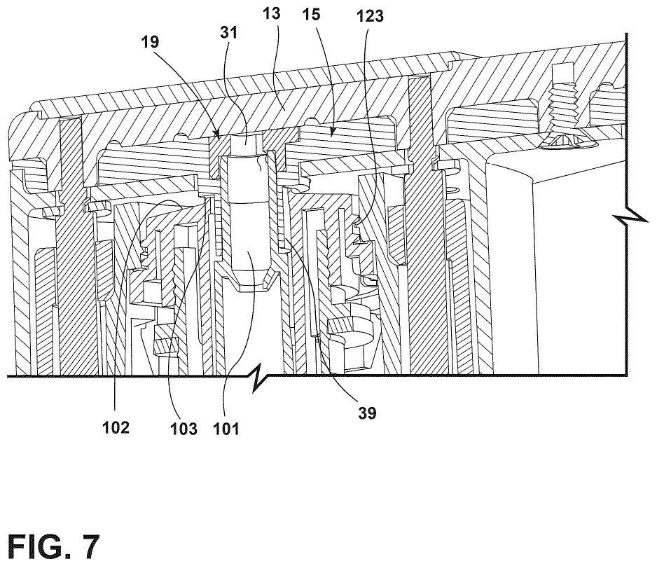

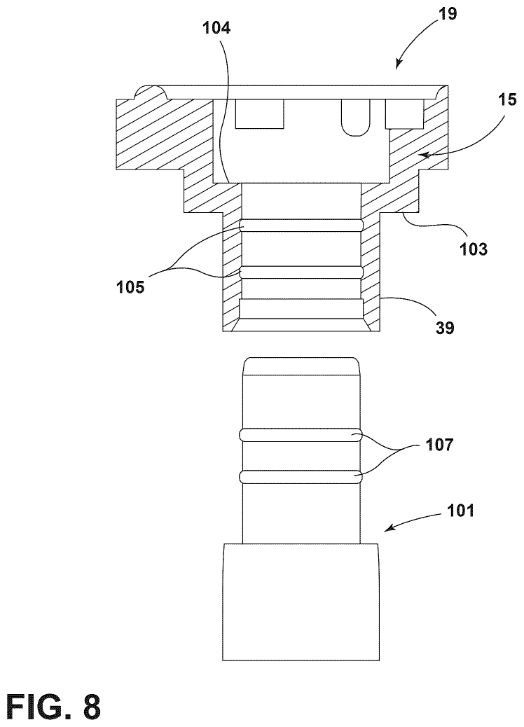

In the illustrative embodiment, inner and outer continuous raised rubber ridges 35, 36, which rise above the flat top surface 16 of the insert 15, are formed around the channels and, when compressed during attachment of the bottom half 17 to the top half 13, form a liquid seal around the liquid flow path. The ridges 35, 36 are high enough above the top surface 16 to form a seal when compressed, but short enough to prevent closure of the liquid flow path channels through expansion of the flexible insert 15. As seen in FIGS. 7 and 8, a flexible vertical inlet channel 39 is formed on and extends from the underside of the insert 15 and is configured to direct and stop a pump stem 101, which is biased against a conforming underside edge 104 of the rigid plastic spacer plug 19.

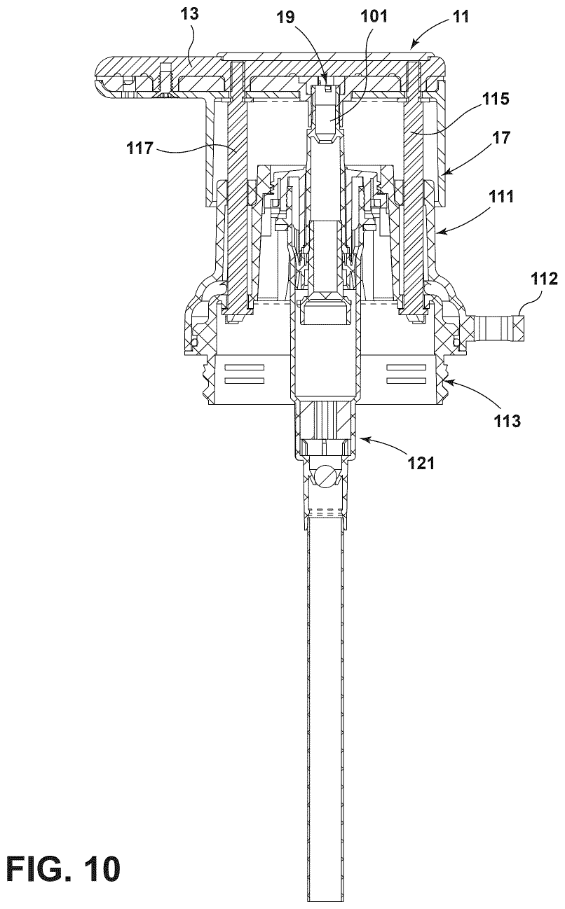

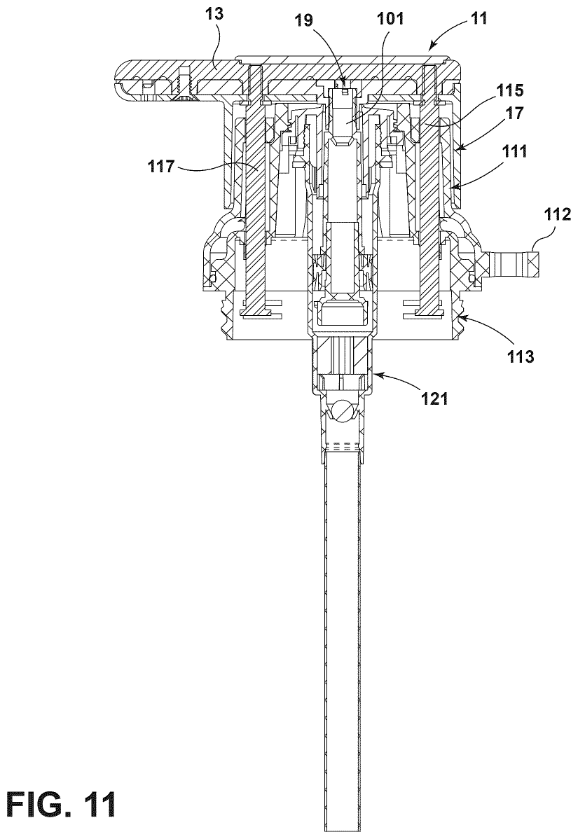

The rigid plastic spacer plug 19 press-fits into a mating opening in the flexible insert 15 so as to form a leak proof seal between the spacer plug 19 and the insert 15. The spacer plug 19 serves to transfer load from a pump stem 101 of a pump engine 121 (FIG. 10) to the underside 37 of the metal pump top 13. The spacer plug 19 is configured to prevent the pump stem 101 from entering and cutting off the fluid flow channels in the flexible insert 15.

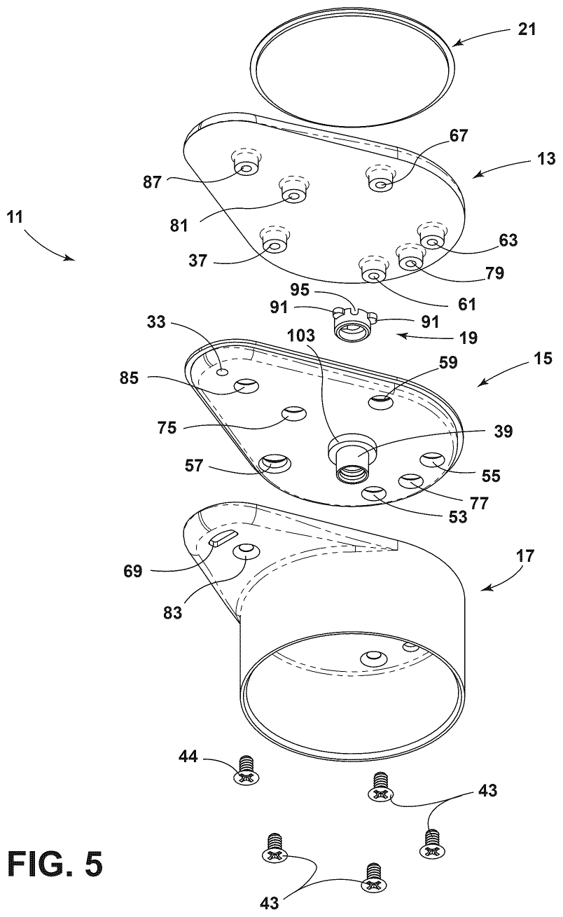

As shown in FIGS. 4 and 5, in the illustrative embodiment, the spacer plug 19 has respective tabs 91 extending from a top surface thereof, which, in the illustrative embodiment, are spaced apart 120 degrees from one another. These tabs 91 mate with respective openings 93 in the insert 15 to radially align the spacer 19 and hold it in position. In the illustrative embodiment, the spacer 19 further has first and second fluid outlet channels 95 spaced apart by 90 degrees, which allow liquid to be dispensed to flow up through the inlet 31 in the spacer 19 and out into the respective flow channels in the insert 15.

In the illustrative embodiment, the flow channels formed in the insert 15 by inner wall 29 and outer wall 27 are sized to provide a consistent cross-sectional area between the spacer outlet channels 95 and the output port 33 (FIG. 6) of the insert 15 in order to maintain a consistent liquid flow rate throughout the flow path. The liquid outlet channels 95 in the spacer 19 have the same cross-sectional area as the flow channels in the insert 15 which they open into.

FIGS. 7 and 8 further illustrate the portion of the flexible insert 15 which receives the rigid plastic spacer 19. As may be seen, the outer surface of the insert 15 is contoured through a right-angle edge 103, which forms into the flexible vertical inlet channel 39, which receives the pump stem 101. The rubber surface of the right-angle edge 103 is located such that it provides a cushion to receive force imparted by a pump surface 102 as the pump top 11 reaches a maximum compression position on a downstroke of the pump top 11. In one embodiment, as shown in FIG. 8, the interior of the inlet channel 39 may have respective flexible receiving grooves 105 positioned to receive and mate with rigid ribs 107 on the pump stem 101 to hold the two parts together and form a liquid seal.

With reference to FIGS. 3 and 5, the inlet channel 39 and the right-angle edge 103 of the insert 15 pass through a circular opening 41 (FIG. 4) in the bottom half 17. In an illustrative embodiment, the insert 15 may be a molded part. In other embodiments, the insert 15 may be formed of other materials, for example, such as a suitable plastic or composite. In illustrative silicone rubber embodiments, the hardness of the silicone rubber may be 25 to 85 Shore A.

In the illustrative embodiment of FIGS. 1-5, to assemble the pump top 11, respective screws or other fastening devices 43 are passed through holes 45, 47, 49, 51 in the bottom half 17, then through respective aligned holes 53, 55, 57, 59 in the insert 15 and then into respective threaded holes 61, 63, 65, 67 in the top half 13. A screw 44 is passed through holes 83, 85 located in the front portion of the bottom half 17 and insert 15, respectively, and threaded into a boss 87 located on the underside of the top half 13 (FIG. 5). This screw 44 functions with the other screws 43 to balance and even out the compressive force exerted on the insert 15.

The medallion 21 is attached in place, e.g. by a suitable adhesive, so as to cover the threaded holes, e.g. 61, 63, 65, 67 in the top half 13.

The sectional view of FIG. 3 particularly illustrates the fluid inlet port 31 of the spacer 19 and below it the flexible vertical inlet channel 39, which receives and mates with a pump stem, e.g., 101, as shown in FIG. 7. A fluid outlet port is formed by respective openings 33, 69 in the bottom pump top half 17 and the silicon rubber insert 15. Respective guide pins 115, 117 (FIG. 10) pass through respective sets of holes 71,73 and 75,77 in the pump top bottom half 17 and the flexible insert 15 and thread into respective holes 79, 81 in the top half 13.

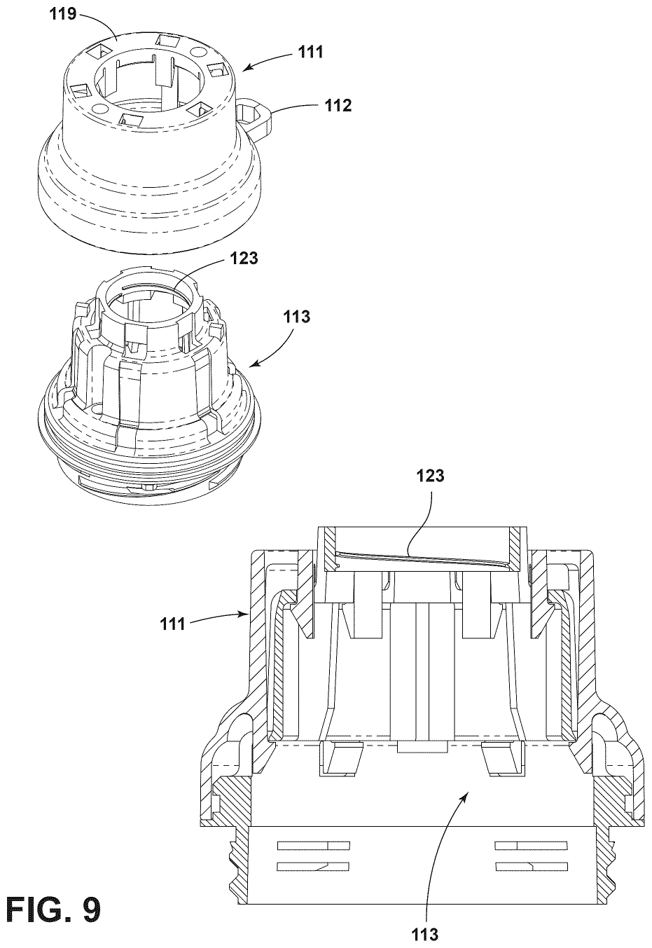

As illustrated in connection with FIGS. 9-11, the pump top 11 is configured to ride up and down with respect to the cylindrical side surface of an upper closure member 111, which snap-fit attaches to a lower closure member 113. The guide pins 115, 117 move up and down in unison with the pump top 11 via respective holes in the top surface 119 of the upper closure member 111 and the lower closure member 113 and serve to position and control the up and down motion of the pump top 11. FIG. 11 illustrates the fully depressed position of the pump top 11 where the guide pins 115, 117 have moved downwardly into a cavity in the lower closure 113.

In operation, in an illustrative embodiment, the pump top 11 is manually depressed to the FIG. 11 position, liquid is dispensed, and the spring action of the pump engine 121 returns the pump top 11 to the position of FIG. 10. In illustrative embodiments, the pump engine 121 may be a commercially available unit but may be modified in various manners in other embodiments.

In an illustrative embodiment, the pump engine 121 threads into the lower closure member 113 via a thread 123 (FIG. 9) and is held in place by that connection. In an illustrative embodiment, the lower closure member 113 is configured to removably attach to a canister and encloses an opening in the canister which receives the pump engine 121 and which, in various embodiments, may store liquid to be pumped or receive a liquid-containing reservoir attached to a pump engine. The upper closure member 111 includes a hook 112, which may serve in removably attaching the closure member 111 and a liquid dispenser of which it is a part to a liquid dispenser housing, for example, as disclosed in U.S. Pat. No. 11,332,279 referenced above.

In assembly in one illustrative embodiment, the upper and lower closure members 111, 113 are snapped together, and the pump engine 121 is attached to the upper closure 111. The pump top 11 is then attached to the upper closure 111 and through the lower closure via the guide pins 115, 117. The closure assembly and attached pump 121 and pump top 11 may then be removably attached to a cooperating canister via various mechanisms.

From the foregoing, those skilled in the art will appreciate that various adaptations and modifications of the just described illustrative embodiments can be configured without departing from the scope and spirit of the invention. For example, in various illustrative embodiments, for corrosion resistance, metallic parts may either be stainless steel, anodized, lacquered, and/or powder coated.

Therefore, it is to be understood that, within the scope of the appended claims, the invention may be practiced other than as specifically described herein.

1. A pump top for a liquid dispenser comprising:
a top half, a bottom half, and a flexible insert positioned between the top and bottom halves;
the flexible insert comprising a liquid guide formed to lie beneath a bottom surface of the top half, the liquid guide being formed by an inner side surface and an outer side surface, the liquid guide comprising a liquid flow path configured to conduct liquid to be dispensed, the flexible insert further comprising a receptacle formed therein and shaped to receive a spacer plug;
a spacer plug positioned in said receptacle and comprising an inlet port configured to receive liquid dispensed from a pump stem and at least one outlet port configured to transfer liquid dispensed from the pump stem into said liquid flow path; and
wherein the spacer plug is configured to transfer force from the pump stem to an undersurface of the top half of the pump top while enabling liquid to flow from the pump stem into the liquid guide.

2. The pump top of claim 1 wherein the flexible insert further comprises a flexible channel extending below the inlet port of the spacer plug for receiving the pump stem and guiding it to the spacer plug.

3. The pump top of claim 2 wherein the flexible channel forms into a right-angle edge configured to provide a cushion against force applied by an adjacent surface of the pump as the pump head reaches a maximum compression position on a downstroke of the pump head.

4. The pump top of claim 3 wherein the spacer plug comprises a plurality of tabs extending from a top surface thereof and configured to mate with respective openings in the flexible insert to radially align the spacer plug and hold it in position.

5. The pump top of claim 4 wherein the plurality of tabs comprises three tabs spaced apart 120 degrees from one another.

6. The pump top of claims 5 wherein the liquid flow path comprises first and second channels and the spacer plug comprises first and second outlet ports for transferring liquid into a respective one of the first and second channels.

7. The pump top of claim 6 wherein the flexible insert further comprises first and second raised flexible ridges formed around the liquid guide and configured such that when the top and bottom halves are attached together, the flexible insert is compressed, and the ridges form a liquid seal around the liquid flow path provided by the liquid guide.

8. The pump top of claim 6 wherein a respective rear perimeter of each of the top half, the bottom half, and the flexible insert follows the same semicircular contour, said contour having a radius.

9. The pump top of claim 6 wherein the flexible insert is sandwiched between the top half and bottom halves such that a top surface of the insert is concealed from view by those two components.

10. The pump top of claim 9 wherein the flexible insert is formed of silicone rubber.

11. The pump top of claim 1 wherein the spacer plug comprises a plurality of tabs extending from a top surface thereof and configured to mate with respective openings in the flexible insert to radially align the spacer plug and hold it in position.

12. The pump top of claim 11 wherein the plurality of tabs comprise three tabs spaced apart 120 degrees from one another.

13. The pump top of claim 1 wherein the liquid flow path comprises first and second channels and the spacer plug comprises first and second outlet ports for transferring liquid into a respective one of the first and second channels.

14. The pump top of claim 1 wherein the flexible insert further comprises first and second raised flexible ridges formed around the liquid guide and configured such that when the top and bottom halves are attached together, the flexible insert is compressed, and the ridges form a liquid seal around the liquid flow path provided by the liquid guide.

15. The pump top of claim 14 wherein a respective rear perimeter of each of the top half, the bottom half, and the flexible insert follows the same semicircular contour, said contour having a radius.

16. The pump top of claim 14 wherein the flexible insert is sandwiched between the top half and bottom halves such that a top surface of the insert is concealed from view by those two components.

17. The pump top of claim 1 wherein the flexible insert is formed of silicone rubber.
